(19) United States
(12) Patent Application Publication
(10) Pub. No.: US 2021/0122296 A1
(43) Pub. Date: Apr. 29, 2021

(54) EASY STEP

(71) Applicant: David Borkowski, Biloxi, MS (US)

(72) Inventor: David Borkowski, Biloxi, MS (US)

(21) Appl. No.: 16/664,831

(22) Filed: Oct. 26, 2019

(51) Int. Cl. B60R 3/02

(52) U.S. Cl. CPC B60R 3/02

(57) ABSTRACT

An illustrated view of an exemplary easy step device for accessing a bed of a pickup. The easy step device is useful for providing a safe, quick and easy step into the bed of the pickup or to have safe, easy and convenient access to items stowed in the bed of the pickup. The easy step device has a receiving bar and a insertion bar that are slidably coupled by sliding the insert bar into or out of the receiving bar. The receiving bar has a hole that when a desired position is attained, then the hole of the receiving bar is aligned with one of a plurality of holes in the insert bar. A pin is then inserted through the hole of the receiving bar and through the aligned hole of the insert bar to securely couple the bars together. A step is coupled to a cross-member that is coupled to the receiving bar. The step is configured to support a foot of a person. The device can further be stabilized by utilizing brackets coupled under a bumper of a pickup truck.

### FIELD OF THE INVENTION

This invention relates to truck beds. More particularly, it relates to devices to gain access the inside of a truck bed.

### BACKGROUND

A pickup truck is a light-duty truck having an enclosed cab and an open cargo area with low sides and tailgate. Once a work tool with few creature comforts, in the 1950s consumers began purchasing pickups for lifestyle reasons, and by the 1990s, less than 15% of owners reported use in work as the pickup truck's primary purpose. Today in North America, the pickup is mostly used as a passenger car and accounts for about 18% of total vehicles sold in the United States.

A regular cab has a single row of seats and a single set of doors, one on each side. Extended or super cab pickups add an extra space behind the main seat, sometimes including small seats. The first extended cab truck in the U.S. was called the Club Cab and was introduced by Chrysler in 1973 on Dodge pickup trucks. A crew cab, or double cab, seats five or six and has four full-sized, front-hinged doors. The first crew cab truck in the U.S. was made by International Harvester in 1957, and was later followed by Dodge in 1963, Ford in 1965, and Chevrolet in 1973.

Cab-over or cab forward designs have the cab sitting above the front axle. An early cab-forward, drop-sided pickup was the Volkswagen Transporter, introduced in 1952. This configuration is more common among European and Japanese manufacturers than in North America, since the style allows a longer cargo area for the same overall length. The design was more popular in North America in the 1950s and '60s, examples including the Chevrolet Corvair Rampside and Loadside, Dodge A-100 and A-108, Ford Econoline, and Jeep FC-150 & FC-170.

The cargo bed can vary in size according to whether the vehicle is optimized for cargo utility or passenger comfort. Most have fixed side walls and a hinged tailgate. Cargo beds are normally found in two styles: step-side or fleet-side. A step-side bed has fenders which extend on the outside of the cargo area. A fleet-side bed has wheel-wells inside the bed. The first fleet-sided truck was the 1955 Chevrolet Cameo Carrier. Early trucks had wood-plank beds, which were largely replaced by steel by the 1960s. Some European-style trucks use a drop-sided bed with a flat tray with hinged panels rising up on the sides and the rear.

A pickup with four rear wheels instead of two is, in North America, called a “dually”, which is able to carry more weight over the rear axle. Vehicles similar to the pickup include the coupe utility, a car-based pickup, the similar but larger sport utility truck (SUT).

The terms half-ton and three-quarter-ton are remnants from a time when the number referred to the maximum cargo capacity by weight.

Often times there is a need to enter a bed of the pickup. The current method to enter the bed is to do one of the following, using a rear bumper as the step, to get a step ladder and use the steps of the ladder to enter the bed, open a tailgate and step onto the tailgate which can severely damage hinges of the tailgate or to step onto a tire. These are all dangerous and can be unattainable if a person wanting to enter the bed area is not agile or a rock climber. Therefore, there is a need for a device which can be used by anyone to step up to gain access to the bed of the pickup.

### BRIEF DESCRIPTION OF THE DRAWINGS

FIG. 1 an illustrated view of an exemplary easy step device.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

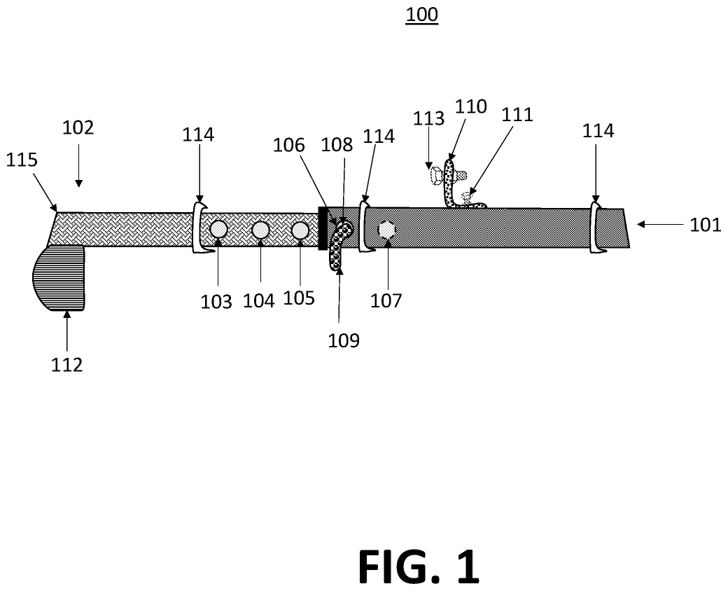

Referring to FIG. 1, an illustrated view of an exemplary easy step device 100 for accessing a bed of a pickup. The easy step device 100 is useful for providing a safe, quick and easy step into the bed of the pickup or to have safe, easy and convenient access to items stowed in the bed of the pickup.

The exemplary easy step device 100 is adjustable in length. The easy step device 100 preferably has a length of twenty-four (24) inches, but other lengths are hereby contemplated, including, but not limited to, twenty (20) inches, eighteen (18) inches, twenty-five (25) inches, twenty-eight (28) inches, etc. The easy step device 100 preferably has a height of two and one-fourth (2.25) inches, but other heights are hereby contemplated, including, but not limited to, two (2) inches, three (3) inches, three and one-half (3.5) inches, etc. The easy step device 100 preferably has a width of eight (8) inches, but other lengths are hereby contemplated, including, but not limited to, six (6) inches, nine (9) inches, etc.

The easy step device 100 preferably is made of a metal material, such as steel, aluminum, titanium, etc., but other materials are hereby contemplated, including, but not limited to, poly-vinyl chloride (PVC), hard-plastic, etc. The shape of the easy step device 100 is preferably square, but other shapes are hereby contemplated, including, but not limited to, rectangular, oblong, round, etc.

The easy step device 100 has a receiving bar 101 and an insert bar 102. The receiving bar 101 is preferably tubular. The insert bar 102 is preferably solid. The insert bar 102 is slidably coupled to the receiving bar 101.

The insert bar 102 has a plurality of holes 103, 104, 105, 106, 107. The receiving bar 101 has a hole 108. A pin 109 is removably coupled to the hole 108 of the receiving bar 101. The pin 109 is then pushed or inserted through the hole 108 of the receiving bar and is removably coupled to the hole 106 of the receiving bar 101 to securely couple the receiving bar 101 to the insert bar 102.

To adjust the length of the easy step device 100, the pin 109 is removed from hole 106 of the insert bar 102 and the hole 108 of the receiving bar 101.

To decrease the length of the easy step device 100, the receiving bar 101 moved such that the insert bar 102 is further into the receiving bar 101 and the hole 108 of the receiving bar 101 is aligned with the hole 103, 104 or 105 of the insert bar 101. The pin 109 is then inserted into the hole 108 of the receiving bar 101 through the aligned hole 103, 104 or 105 of the insert bar 101.

To increase the length of the easy step device 100, the receiving bar 101 moved such that the insert bar 102 is further into the receiving bar 101 and the hole 108 of the receiving bar 101 is aligned with the hole 107 of the insert bar 101. The pin 109 is then inserted into the hole 108 of the receiving bar 101 through the aligned hole 107 of the insert bar 101. Thus, the length of the easy step device 100 is adjustable in length easily and securely.

The receiving bar 101 has a cross member 110. The cross-member 110 is securely coupled to the receiving bar 101 by a connector 111. The cross-member 110 is coupled significantly near a middle portion of a back of the pickup. The connector 111 is preferably a weld, but other connectors are hereby contemplated, including, but not limited to, a nut and bolt, a screw and nut, a slidable latch, etc.

The easy step device 100 further has a step 112. The step 112 is coupled to substantially near a first end 115 the insert bar 102 preferably by a weld. The step 112 is configured to accommodate a foot of a person. The step 112 is preferably a weld, but other connectors are hereby contemplated, including, but not limited to, a nut and bolt, a screw and nut, a slidable latch, etc.

Optionally and/or additionally, a plurality of brackets 114 may be coupled under a bumper of a pickup truck. The brackets 114 are useful for further securing the length of the easy step device 100 such that it is fully supported for its entire length. Once the brackets 114 are coupled to under the bumper of the truck on some applications, then the easy step device 110 may be inserted into the brackets 114.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An easy step device for providing access to a bed of a pickup truck, the device comprising:
a receiving bar, the receiving bar having a hole;
an insert bar, the insert bar having a plurality of holes;
the insert bar being slidably coupled to the receiving bar, wherein the hole of the receiving bar being aligned with one of the plurality of holes of the insert bar, and wherein the receiving bar being coupled to the insert bar by a pin being inserted through the hole of the receiving bar and the aligned one of the plurality of holes of the insert bar; and
a cross-member, the cross-member being securely coupled to the receiving bar by a connector; and
a step, the step being configured to be securely coupled to the insert bar.

2. The device of claim 1, wherein the device having a length of twenty-four (24) inches.

3. The device of claim 1, wherein the device having a width of eight (8) inches.

4. The device of claim 1, wherein the device having a height of two and one-fourth (2.25) inches.

5. The device of claim 1, wherein device being made of a metal material.

6. The device of claim 5, wherein the metal material being steel.

7. The device of claim 1, wherein the device being an adjustable length.

8. The device of claim 1, wherein the device being a square shape.

9. The device of claim 1, wherein the device further comprising:
a plurality of brackets, wherein the plurality of brackets being coupled under a bumper of the pickup truck; and
wherein the device being slidably coupled to an inside of the plurality of brackets.

10. The device of claim 1, wherein the connector of the cross-member being a nut and bolt.

11. The device of claim 1, wherein the connector of the step being a weld.

12. The device of claim 1, wherein the step being removable.

13. The device of claim 1, wherein the pin being removable.
